(19) United States
(12) Patent Application Publication
(10) Pub. No.: US 2011/0319262 A1
(43) Pub. Date: Dec. 29, 2011

(54) PESTICIDAL COMBINATIONS CONTAINING SULFOXAFLOR

(75) Inventors: Michael Schade, Basel (CH); Christoph Grimm, Stein (CH); Martin Faerber, Basel (CH); Dieter Hofer, Basel (CH); Kaspar Müller, Basel (CH); Scott Campbell, Basel (CH)

(73) Assignee: SYNGENTA CROP PROTECTION, LLC, Greensboro, NC (US)

(21) Appl. No.: 13/123,453

(22) PCT Filed: Sep. 16, 2009
(86) PCT No.: PCT/EP2009/062000

§ 371 Date: Jul. 18, 2011

(30) Foreign Application Priority Data
Oct. 8, 2008 (GB) 0818482.2
Nov. 21, 2008 (GB) 0821367.0
Nov. 21, 2008 (GB) 0821368.8
Nov. 21, 2008 (GB) 0821370.4

(51) Int. Cl. A01N 43/40; A01P 5/00; A01P 3/00; A01P 7/04; A01C 1/06; A01N 43/88

(52) U.S. Cl. 504/100; 514/357; 514/229.2

(57) ABSTRACT

A combination, suitable for agricultural use comprising (I): a compound of formula (X) and (II): one or more agents selected, independently of each other, from any one of (A) to (G): (A) a certain fungicide; (B) a certain insecticide and/or nematicide; (C) a certain protein produced by the plant pathogenic bacterium, Erwinia amylovora; (D) a certain biological strain, (E) a certain Isoflavone; (F) a plant growth regulator; and (G) a plant activator, wherein compound of formula (X) is:

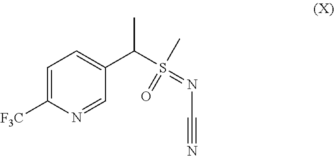

The present invention relates to the use of a combination of a specific insecticidal active ingredient and one or more defined agents or compounds used in agriculture to improve the growing characteristics of a plant, and methods for using such combinations in the control or prevention of damage by pests, such as insect, nematode and pathogen, especially in the agricultural field.

Certain active ingredients, agents and combinations are described in the literature for improving the plant growth; however, efficacy of such known uses do not always satisfy the needs of agricultural practice in many incidents and aspects. There is a continuing need to provide improved combinations, which provide better, for example, biological properties, for example, synergistic properties, especially for controlling pests. Further, biological properties of the known combinations are not entirely satisfactory in the areas of pest control, phytotoxicity, and environmental and worker exposure, for example. In particular, in the instance a pest has become, or risks becoming resistant to the known compositions or active ingredients, improved methods of control or prevention are sought.

In a particular embodiment, the protection of plant propagation materials (especially seeds) with ingredients are target applications which partially address the need for a reduction of environmental and worker exposure when used alone or in conjunction with foliar or in-furrow active ingredient applications.

It is now been found that a particular combination of a specific insecticidal active ingredient and one or more defined agents (such as agents that provide growing characteristics to a plant through control of pests, through making available nutrients, through activating the plant growth properties, e.g. natural defence mechanism, etc, and alike) provide unexpected control or prevention of damage by pests to a plant, when the particular ingredients of the defined combination is applied, in any desired sequence or simultaneously, on the plant, part of a plant, plant organ, and/or plant propagation material thereof, or surrounding area thereof.

Accordingly, the present invention provides a combination, particularly a pesticidal combination, suitable for agricultural use comprising (I) a compound of formula (X) and (II) one or more agents selected, independently of each other, from any one of (A) to (G):
(A) a fungicide ingredient selected from azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β);
(B) an insecticide or nematicide ingredient selected from thiamethoxam, clothianidin, imidacloprid, abamectin, fipronil, pymetrozine, lambda-cyhalothrin, tefluthrin, beta-cyfluthrin, thiodicarb, compound of formula (δ);
(C) Harpin;
(D) a biological strain selected from Bacillus firmus strain I-1582;
(E) an isoflavone selected from Formononetin, Genistein;
(F) a plant growth regulator, such as paclobutrazol, trinexapac-ethyl, and gibberellins GA3, GA7 or a mixture thereof; and
(G) a plant activator, such as acibenzolar-S-methyl,
   wherein compound of formulae (X), (α), (β), and (δ) are:
   a compound (X)

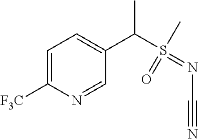

a compound (α)

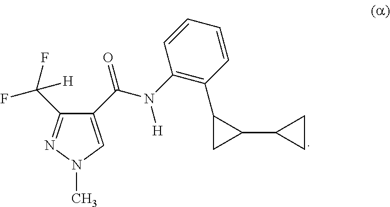

a compound (β)

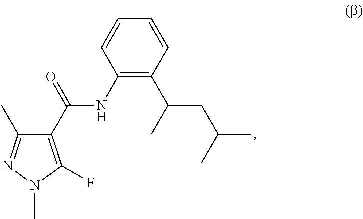

compound (δ)

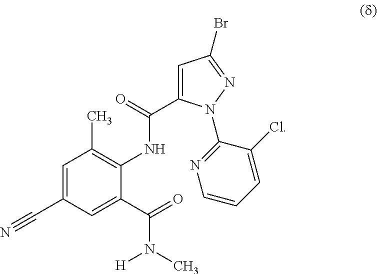

In a second aspect, the present invention provides a method of controlling or preventing pest damage in a plant propagation material, a plant, part of a plant and/or plant organ that grow at a later point in time, which comprises applying on the pest, plant, part of the plant, plant organ, plant propagation material or a surrounding area thereof, the ingredients of the combination as defined in the first aspect, in any desired sequence or simultaneously.

In a third aspect, the present invention provides a method of protecting a plant propagation material, a plant, part of a plant and/or plant organ that grow at a later point in time against pest damage by applying to the pest, plant, part of plant, plant organ, plant propagation material or a surrounding area thereof the ingredients of the combination, as defined in the first aspect, in any desired sequence or simultaneously.

The invention also relates to a plant propagation material treated with each of the combination defined in the first aspect.

Further, in an embodiment the present invention relates to a method which comprises (i) treating a plant propagation material, such as a seed, with a combination as defined in the first aspect, and (ii) planting or sowing the treated propagation material, wherein the combination protects against pest damage of the treated plant propagation material, or part of plant, plant organ and/or plant grown from the treated propagation material.

Also, in an embodiment the present invention relates to a method which comprises (i) treating a plant propagation material, such as a seed, with a combination as defined in the first aspect, and (ii) planting or sowing the treated propagation material, and (iii) achieving protection against pest damage of the treated plant propagation material, or part of plant, plant organ and/or plant grown from the treated propagation material.

In an embodiment of any aspects of the invention, the combination is a composition comprising, preferably of, (I) a compound formula (X) and (II) one or more pesticidal agents selected from (A) azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), and compound of formula (β), and optionally (III) one or more customary formulation auxiliaries.

In an embodiment of any aspects of the invention, the combination is a composition comprising, preferably of, (I) a compound formula (X) and (II) one or more pesticidal agents selected from (B) thiamethoxam, clothianidin, imidacloprid, abamectin, fipronil, lambda-cyhalothrin, tefluthrin, beta-cyfluthrin, thiodicarb, and compound of formula (δ), and optionally (III) one or more customary formulation auxiliaries.

In an embodiment of any aspects of the invention, the combination is a composition comprising, preferably of, (I) a compound formula (X) and (II) (C) harpin, and optionally (III) one or more customary formulation auxiliaries.

In an embodiment of any aspects of the invention, the combination is a composition comprising, preferably of, (I) a compound formula (X) and (II) (D) Bacillus firmus strain I-1582, and optionally (III) one or more customary formulation auxiliaries.

In an embodiment of any aspects of the invention, the combination is a composition comprising, preferably of, (I) a compound formula (X) and (II) one or more agents selected from (E) Formononetin and Genistein, and optionally (III) one or more customary formulation auxiliaries.

In an embodiment of any aspects of the invention, the combination is a composition comprising, preferably of, (I) a compound formula (X) and (II) one or more agents selected from (F) a plant growth regulator, such as paclobutrazol, trinexapac-ethyl, and gibberellins GA3, GA7 or a mixture thereof, and optionally (III) one or more customary formulation auxiliaries.

In an embodiment of any aspects of the invention, the combination is a composition comprising, preferably of, (I) a compound formula (X) and (II) one or more agents selected from (G) a plant activator, such as acibenzolar-S-methyl, and optionally (III) one or more customary formulation auxiliaries.

In an embodiment the combination comprises, preferably is, a compound of formula (X), and either ortho-cyclopropyl-carboxanilide of formula (α) or compound of formula (β).

A particularly preferred combination comprises, preferably is, a compound of formula (X), (B) one or more of thiamethoxam, abamectin, lambda-cyhalothrin, tefluthrin, and (A) one or more of azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β).

In an embodiment the combination comprises, preferably is, a compound of formula (X), (B) thiamethoxam, and (A) one or more of azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β).

In an embodiment the combination comprises, preferably is, a compound of formula (X), (B) abamectin and (A) one or more of azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (a), compound of formula (β).

In an embodiment the combination comprises, preferably is, a compound of formula (X), (B) lambda-cyhalothrin, and (A) one or more of azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β).

In an embodiment the combination comprises, preferably is, a compound of formula (X), (B) tefluthrin, and (A) one or more of azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β).

In an embodiment the combination comprises, preferably is, a compound of formula (X), (B) thiamethoxam, and (A) one or more of abamectin, lamba-cyhalothrin, tefluthrin, fipronil and a compound of formula (δ). In a further embodiment, the combination comprises a compound of formula (X), (B) thiamethoxam, and (A) one or more of abamectin, lamba-cyhalothrin, tefluthrin, fipronil and a compound of formula (6), and optionally one or more compounds selected from (A) azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β).

Examples of further combinations include compositions comprising, preferably of, a compound of formula (X) and any one of

(a) clothianidin and harpin;
(b) imidacloprid and harpin;
(c) imidacloprid and thiodicarb;
(d) clothainidin and imidacloprid;
(e) clothianidin & beta-cyfluthrin;
(f) clothianidin & tefluthrin;
(g) imidacloprid & tefluthrin; and
(h) fipronil and either or both clothainidin and imidacloprid.

In a preferred embodiment the combination is in the form of a composition, which composition further comprises (III) one or more customary formulation auxiliaries. In a preferred embodiment, each combination is a composition that is in the form of a pre-mix formulated composition.

Each combination can demonstrate synergistic activity compared to the activity of the individual ingredients in the combination. There may be more than one agent, independently of each combination, from (II).

Controlling, preventing or protecting and its inflections, within the context of the present invention, mean reducing any undesired effect, such as

infestation or attack, and

damage,

by a pest on a plant, part of the plant or plant propagation material to such a level that an improvement is demonstrated.

Each combination according to the invention has very advantageous properties for protecting plants against, for example, (i) pathogenic, such as phytopathogenic, especially fungi, attack or infestation, which result in disease and damage to the plant and/or (ii) insect or nematode attack or damage; particularly in the instance of plants, the present invention can control or prevent the pest damage on a seed, or parts of plant, plant organs and/or plants Further, a combination according to the invention, in the absence of pathogenic or insect and/or nematode pressure, improves the growth of a plant.

These properties are for example the synergistically enhanced actions of combinations compared to the individual ingredients of the combination (e.g. (I), and (II)), resulting in, for example, lower pathogenic pest damage, lower rates of application, or a longer duration of action. In the instance of agriculture, the enhanced actions are found to show an improvement in the growing characteristics of a plant by, for example, higher than expected control of the pest damage, or higher than expected yield, stand establishment, germination, etc.

The improvement in the growing (or growth) characteristics of a plant can manifest in a number of different ways, but ultimately it results in a better product of the plant. It can, for example, manifest in improving the yield and/or vigour of the plant or quality of the harvested product from the plant, which improvement may not be connected to the control of pests, such as fungi, insects and nematodes.

As used herein the phrase “improving the yield” of a plant relates to an increase in the yield of a product of the plant by a measurable amount over the yield of the same product of the plant produced under the same conditions, but without the application of the subject method. It is preferred that the yield be increased by at least about 0.5%, more preferred that the increase be at least about 1%, even more preferred is about 2%, and yet more preferred is about 4%, or more. Yield can be expressed in terms of an amount by weight or volume of a product of the plant on some basis. The basis can be expressed in terms of time, growing area, weight of plants produced, amount of a raw material used, or the like.

As used herein the phrase “improving the vigour” of a plant relates to an increase or improvement of the vigour rating, or the stand (the number of plants per unit of area), or the plant height, or the plant canopy, or the visual appearance (such as greener leaf colour), or the root rating, or emergence, or protein content, or increased tillering, or bigger leaf blade, or less dead basal leaves, or stronger tillers, or less fertilizer needed, or less seeds needed, or more productive tillers, or earlier flowering, or early grain maturity, or less plant verse (lodging), or increased shoot growth, or earlier germination, or any combination of these factors, or any other advantages familiar to a person skilled in the art, by a measurable or noticeable amount over the same factor of the plant produced under the same conditions, but without the application of the subject method. This results in the plant being able to better manage both abiotic and biotic stresses, such as plants are able to grow under sub-optimal conditions.

When it is said that the present method is capable of “improving the yield and/or vigour” of a plant, the present method results in an increase in either the yield, as described above, or the vigor of the plant, as described above, or both the yield and the vigor of the plant.

In an embodiment, application to a plant, or propagation material thereof, a combination of compound of formula (X) and any one of thiamethoxam, compound of formula (δ) or compound of formula (a) provides improved yield and/or vigour. The application of the combination helps counter possible negative field conditions which expose plants to various stress factors, such as drought and floods

Accordingly, the present invention also provides a method of improving the growing characteristics of a plant, which comprises applying to the plant, part of plant, and/or plant propagation material, the ingredients of the combination, as defined in the first aspect, in any desired sequence or simultaneously, especially in the absence of pathogenic or pests pressure.

Each of the combinations of the invention can be used in the agricultural sector and related fields of use for controlling or preventing damage by pests, such as insect, nematode and pathogen, especially in the agricultural field.

Each of the combinations according to the present invention, especially those containing (II) one or more pesticidal agents selected, independently from each other, from (B), (C), and (D), is effective for pest control, such as control of pests selected from Nematoda, Insecta and Arachnida. In that instance, the combination can also be applied on the pest to control or prevent pest damage and protect the desired material (e.g. plant and part of plant) from pest damage. Examples of pests include:

from the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.;
from the order Coleoptera, for example, Agriotes spp., Anthonomus spp., Atomaria linearis, Chrysomelidae, Ceutorhynchus spp., Chaetocnema tibialis, Cosmopolites spp., Curculio spp., Dermestes spp., Diabrotica spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Sternechus spp., Tenebrio spp., Tribolium spp. and Trogoderma spp.;
from the order Orthoptera, for example, Blatta spp., Blattella spp., Gryllotalpa spp., Leucophaea maderae, Locusta spp., Periplaneta spp. and Schistocerca spp.;
from the order Isoptera, for example, Reticulitermes spp.;
from the order Psocoptera, for example, Liposcelis spp.;
from the order Anoplura, for example, Haematopinus spp., Linognathus spp., Pediculus spp., Pemphigus spp. and Phylloxera spp.;
from the order Mallophaga, for example, Damalinea spp. and Trichodectes spp.;
from the order Thysanoptera, for example, Frankliniella spp., Hercinothrips spp., Megalurothrips spp., Taeniothrips spp., Thrips spp., Thrips palmi, Thrips tabaci and Scirtothrips aurantii;
from the order Heteroptera, for example, Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.;
from the order Homoptera, for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nasonovia spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri;
from the order Hymenoptera, for example, Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.;
from the order Diptera, for example, Antherigona soccata, Bibio hortulanus, Ceratitis spp., Chrysomyia spp., Culex spp., Cuterebra spp., Dacus spp., Delia spp., Drosophila melanogaster, Liriomyza spp., Melanagromyza spp., Orseolia spp., Oscinella frit, Pegomyia hyoscyami, Phorbia spp., Rhagoletis pomonella, Sciara spp.;
from the order Acarina, for example, Acarus siro, Aceria sheldoni, Aculus schlechtendali, Amblyomma spp., Argas spp., Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; and
from the class Nematoda, for example, the species of Tylenchus spp., Atylenchus spp., Anguina spp., Rotylenchus spp., Criconema spp., Tylenchulus spp., Paratylenchus spp., Aphenlenchus spp., Bursaphelenchus spp., Paralongidorus spp., Trichodorus spp., Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonolaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

In an embodiment, each combination containing (II) one or more pesticidal agents selected, independently from each other, from (B), (C), and (D), is effective for control of a pest selected from family Chrysomelidae, family Aphididae, family Psyllidae (such as Empoasca spp., Nilaparvata spp., and Psylla spp.), plant feeding insects from the order Thysanoptera (such as Frankliniella spp., Hercinothrips spp., Taeniothrips spp., Thrips spp., Thrips palmi, Thrips tabaci and Scirtothrips aurantii), order Coleoptera (such as Leptinotarsa decemlineata) and order Homoptera (such as Aleyrodes brassicae, Bemisia tabaci, and Trialeurodes vaporariorum).

In particular, in the stance (II) is a thiamethoxam, clothianidin or imidacloprid, the combination is effective for control of pests that demonstrate non-sensitivity or resistance to the active ingredients, such as those selected from family Aphididae (such as Aphis gossypii, Myzus persicae, Nasonovia spp.), Nilaparvata lugens, Empoasca spp., Bemisia tabaci, Trialeurodes vaporariorum and Leptinotarsa decemlineata; and also effective for control of pests selected from order Coleoptera (including leaf-feeding and soil-living Coleoptera).

The combination comprising compound of formula (X), thiamethoxam and one selected from abamectin, fipronil, lambda-cyhalotthrin, tefluthrin and compound of formula (δ) can be effective for control of pests selected from sucking insects of the order Homoptera such as Aphids (e.g. Aphis spp., Acyrtosiphon spp., Myzus spp., Rhopalosiphum spp., etc.), Leafhoppers (Cicadellidae, e.g. Circulifer spp., Empoasca spp., Sophonia spp., Homalodisca spp., Orosius spp., Typhlocyba spp., Heteroptera such as true bugs, stink bugs (e.g. Dichelops spp.) etc., Whiteflies such as Bemisia spp., Trialeurodes spp., and Delphacidae such as Nilaparvata spp.). Thrips (Thysanoptera, e.g. Thrips spp., Heliothrips spp., Frankliniella spp., Scirthothrips spp., etc.). In the instance the combination comprises abamectin, the combination can also control Nematodes; in the instance the combination comprises fipronil, the combination can also control pests selected from the order Lepidoptera; in the instance the combination comprises compound of formula (δ), the combination can also control pests selected from the order Lepidoptera and soil pests of the order Coleoptera; in the instance the combination comprises lambda cyhalothrin, the combination can also control pests selected soil pests of the order Coleoptera; and in the instance the combination comprises tefluthrin, the combination can also control pests selected from soil pests of the order Coleoptera, and can have bird repellency characteristics.

In the instance a combination contains (II) one or more pesticidal agents selected from (A), according to the present invention, such a combination is also effective against phytopathogenic fungi, especially occurring in plants, including seedborne fungi and belong to the following classes: Ascomycetes (e.g. Penicillium, Gaeumannomyces graminis); Basidiomycetes (e.g. the genus Hemileia, Rhizoctonia, Puccinia), Fungi imperfecti (e.g. Botrytis, Helminthosporium, Rhynchosporium, Fusarium, Septoria, Cercospora, Alternaria, Pyricularia and Pseudocercosporella herpotrichoides); Oomycetes (e.g. Phytophthora, Peronospora, Bremia, Pythium, Plasmopara); Zygomycetes (e.g., Rhizopus spp.). A combination is especially effective against Alternaria spp., Aspergillus spp., Ascochyta spp., Botrytis cinerea, Cercospora spp., Claviceps purpurea, Cochliobolus spp. (such as Cochliobolus sativus), Colletotrichum spp., Diplodia maydis, Epicoccum spp., Erysiphe graminis, Fusarium spp. (such as Fusarium culmorum, Fusarium subglutinans, Fusarium oxysporium, Fusarium solani, Fusarium graminearum, Fusarium proliferatum, and Fusarium moniliforme), Gaeumannomyces graminis, Giberella fujikuroi, Giberella zeae, Helminthosporium graminearum, Microdochium nivale, Monographella nivalis, Penicillium spp., Puccinia spp., Pyrenophora spp. (such as Pyrenophora graminea), Peronosclerospora spp., Peronspora spp., Phakopsora pachyrhizi, Phythium spp., Phoma spp., Phomopsis spp., Rhizoctonia solani, Rhizoctonia cerealis, Septoria spp., Pseudocercosporella spp., Sclerotinia spp., Sphacelotheca reilliana, Tilletia spp., Rhizopus spp., Typhula spp., Ustilago spp., Urocystis occulta, Sphacelotheca spp. (e.g. Spacelotheca reilliani), Thielaviopsis basicola, Typhula incarnata, Thanatephorus cucumeris, and Verticillium spp.

In the instance a combination contains (II) (C) Harpin, such a combination is also effective for improving the growth of a plant through, for example, activating the natural defence mechanism in the host plant, referred to as systemic acquired resistance (SAR) and/or nematode control, such as Meloidogyne spp. (for example, Heterodera spp. (for example, Heterodera glycines, Heterodera schachtii, Heterodora avenae and Heterodora trifolii).

In the instance a combination contains (II) (D) Bacillus firmus strain I-1582 or (II) (C) Harpin, such a combination is also effective for a pest selected the species of Tylenchus spp., Atylenchus spp., Anguina spp., Rotylenchus spp., Criconema spp., Tylenchulus spp., Paratylenchus spp., Aphenlenchus spp., Bursaphelenchus spp., Paralongidorus spp., Trichodorus spp., Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonlaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

Isoflavones are plant chemicals which occur largely in members of the Leguminosae plant family and two such examples are those defined in (II) (E). They are based on a simple diphenolic ring structure as described for example by Carlson et al (1980) Journal of Chromotography, 198, 193-197 and U.S. Pat. No. 7,033,621, the contents of which are incorporated by reference. Examples of isoflavones include, but are not limited to, genistein, biochanin A, formononetin, daidzein, glycitein, hesperetin, naringenin, chalcone, coumarin, Ambiol (2-methyl-4-[dimethylaminomethyl]-5-hydroxybenzimidazole), ascorbate and pratensein and the salts and esters thereof. The present invention contemplates the use of both naturally-occurring and synthetic isoflavone compounds.

In the instance a combination contains (II) one or more agents (E), such a combination is also effective for improving the growth of a plant through, for example, better availability of nutrients to the plant, such as water, and sulfates, nitrates, phosphates and metals, by improving the uptake by the roots.

In the instance a combination contains (II) one or more agents (F) and/or (G), such a combination is also effective for enhancing the plants' traits. Examples of enhanced plant traits include, but are not limited to, increased stem girth, change in leaf color, early flowering, synchronization in flowering, decrease in the lodging, control of the canopy size of a plant, delaying or eliminating tie-up of crops, increase in the disease resistance, enhancing the water utilization/improving the water use efficiency, including but not limited to decreasing the watering and/or less frequent watering (demonstrated by less wilting of the plant, the ability of the plant to rejuvenate following a suspension in watering), higher yield, higher quality/healthier plant appearance, greater transportability, decreasing the insect damage, and smaller plant canopies. Synchronized flowering is indicated by blooms materializing within 0.5 to 1 days of one another throughout the entire crop. Such a combination is particularly well suited for use for plants and propagation material thereof which are transplanted.

In an embodiment, further agent(s), such as active ingredient(s), can be used with each combination according to the present invention. Therefore, each of the combinations of the present invention may be mixed with, for example, one or more other known pesticides, such as other fungicides, insecticides, nematicides, etc. The use of additional agents, such as other active ingredients, can be for reasons, for example, broader spectrum control (e.g. wider variety of pests, diseases, etc), lower rates, synergy and economy. A skilled person would understand that a single pesticidal active ingredient may have activity in more than one area of pest control, for example, a pesticide may have fungicide, insecticide and nematicide activity. Specifically, aldicarb is known for insecticide, acaricide and nematicide activity, while metam is known for insecticide, herbicide, fungicide and nematicide activity, and thiabendazole and captan can provide nematicide and fungicide activity.

Each of the combinations of the invention can be formulated for a particular use. Preferably, each combination is formulated for protecting cultivated plants or their propagation materials. Accordingly, each combination of the invention can be applied to the plant in a conventional manner, such as foliar spray. Advantageously, each of the combinations are formulated for plant propagation material, such as seed, treatment applications for improving the growth of a plant derived from the treated material (or seed), for example, by controlling or preventing damage by pests and/or pathogens, which are found in agriculture and forestry, and can particularly damage the plant in the early stages of its development.

Further, the present invention also envisages soil application of the combinations of the invention to control the soil-dwelling pests and/or soil-borne pathogens. Methods of applying to the soil can be via any suitable method, which ensures that the combination penetrates the soil, for example, nursery tray application, in furrow application, soil drenching, soil injection, drip irrigation, application through sprinklers or central pivot, incorporation into soil (broad cast or in band) are such methods.

The benefits from the invention can also be achieved either by (i) treating plant propagation material with a combinaton or (ii) applying to the locus where control is desired, generally the planting site, the combination, or both (i) and (ii). Indeed, the benefits from the invention can also be achieved by treating plant propagation material with one or more of the ingredients of the combinaton, and then applying to the locus where control is desired with the other ingredient(s) of the combination.

The term “plant propagation material” is understood to denote all the generative parts of the plant, such as seeds, which can be used for the multiplication of the latter and vegetative plant materials such as cuttings and tubers (for example, potatoes). Accordingly, as used herein, part of a plant includes propagation material. There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. These young plants may be protected before transplantation by a total or partial treatment by immersion.

Parts of plant and plant organs that grow at later point in time are any sections of a plant that develop from a plant propagation material, such as a seed. Parts of plant, plant organs, and plants can also benefit from the pest damage protection achieved by the application of each combination on to the plant propagation material. In an embodiment, certain parts of a plant and certain plant organs that grow at later point in time can also be considered as plant propagation material, which can themselves be applied (or treated) with the combination; and consequently, the plant, further parts of the plant and further plant organs that develop from the treated parts of plant and treated plant organs can also benefit from the pest damage protection achieved by the application of each combinations on to the certain parts of plant and certain plant organs.

Methods for applying or treating pesticidal active ingredients and mixtures thereof on to plant propagation material, especially seeds, are known in the art, and include dressing, coating, pelleting and soaking application methods of the propagation material. Such methods are also applicable to the combinations according to the invention. In a preferred embodiment, the combination is applied or treated on to the plant propagation material by a method such that the germination is not induced; generally seed soaking induces germination because the moisture content of the resulting seed is too high. Accordingly, examples of suitable methods for applying (or treating) a plant propagation material, such as a seed, is seed dressing, seed coating or seed pelleting and alike.

It is preferred that the plant propagation material is a seed.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

Even distribution of the ingredients in the combination and adherence thereof to the seeds is desired during propagation material treatment. Treatment could vary from a thin film (dressing) of the formulation containing the combination, for example, a mixture of active ingredient(s), on a plant propagation material, such as a seed, where the original size and/or shape are recognizable to an intermediary state (such as a coating) and then to a thicker film (such as pelleting with many layers of different materials (such as carriers, for example, clays; different formulations, such as of other active ingredients; polymers; and colourants) where the original shape and/or size of the seed is no longer recognisable.

An aspect of the present invention includes application of the combinations onto the plant propagation material in a targeted fashion, including positioning the ingredients in the combination onto the entire plant propagation material or on only parts thereof, including on only a single side or a portion of a single side. One of ordinary skill in the art would understand these application methods from the description provided in EP954213B1 and WO06112700.

The combinations described herein can also be used to enhance the growth of a plant through treating, or applying, a combination according to the present on to a “pill” or a suitable substrate and placing, or sowing, the treated pill, or substrate, next to a plant propagation material. Such techniques are known in the art, particularly in EP1124414, WO07067042, and WO07067044.

Application of the combinations described herein onto plant propagation material also includes protecting the plant propagation material treated with the combination of the present invention by placing one or more pesticide-containing particles next to a pesticide-treated seed, wherein the amount of pesticide is such that the pesticide-treated seed and the pesticide-containing particles together contain an Effective Dose of the pesticide and the pesticide dose contained in the pesticide-treated seed is less than or equal to the Maximal Non-Phytotoxic Dose of the pesticide. Such techniques are known in the art, particularly in WO2005/120226.

Application of the combinations onto the seed also includes controlled release coatings on the seeds, wherein the ingredients of the combinations are incorporated into materials that release the ingredients over time. Examples of controlled release seed treatment technologies are generally known in the art and include polymer films, waxes, or other seed coatings, wherein the ingredients may be incorporated into the controlled release material or applied between layers of materials, or both.

Seed can be treated by applying thereto the insecticidal compound (I) and at least one agent (II) in any desired sequence or simultaneously.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the active ingredient is applied to the soil but would include any application practice that would target the seed during the planting process.

Preferably, the treatment occurs before sowing of the seed so that the sown seed has been pre-treated with the combination. In particular, seed coating or seed pelleting are preferred in the treatment of the combinations according to the invention. As a result of the treatment, the ingredients in each combination are adhered on to the seed and therefore available for pest control.

The treated seeds can be stored, handled, sowed and tilled in the same manner as any other active ingredient treated seed.

Each combination according to the present invention is suitable for plants of the crops: cereals, such as wheat, barley, rye, oats, rice, maize (fodder maize and sugar maize/sweet and field corn) or sorghum; beet, such as sugar or fodder beet; fruit, for example pomaceous fruit, stone fruit, tree nut or soft fruit, such as apples, pears, plums, peaches, bananas, almonds, walnuts, pistachios, cherries or berries, for example strawberries, raspberries or blackberries; leguminous crops, such as beans, lentils, peas or soya; oil crops, such as oilseed rape, mustard, poppies, olives, sunflowers, coconut, castor, cocoa or ground nuts; cucurbits, such as pumpkins, marrow, cucumbers or melons; fibre plants, such as cotton, flax, hemp or jute; citrus fruit, such as oranges, lemons, grapefruit or tangerines; vegetables, such as spinach, lettuce, asparagus, cabbages, iceberg, carrots, onions, tomatoes, paprika, potatoes or bell peppers; Lauraceae, such as avocado, Cinnamonium or camphor; and also tobacco, nuts, coffee, eggplants, sugarcane, tea, pepper, grapevines, hops, the plantain family, latex plants, lawn, turf, fodder grass, and ornamentals, such as petunias, geranium/pelargoniums, pansies and impatiens; and shrubs, broad-leaved trees and evergreens, such as conifers. In particular, the combination is suitable for coffee, citrus, stone fruits (especially apple, pears, plums, peaches), tree nuts (especially almonds and pistachios), and vegetable crops. In particular, cotton, soya, cereals (such as maize).

Each of the combinations according to the present invention are particularly suitable for use in Corn, Cereals (including Rice), Oil Seeds Rape & Canola, Soybean, Cotton, Sugar Beet, Sunflower, Potato, Beans, Sorghum, Peas, Peanuts, as well as Vegetables such as Cale Crops, and Fruiting Vegetables.

Suitable target crops also include transgenic crop plants of the foregoing types. The transgenic crop plants used according to the invention are plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance. Examples of such toxins, or transgenic plants which are capable of synthesizing such toxins, have been disclosed, for example, in EP-A-0 374 753, WO 93/07278, WO 95/34656, EP-A-0 427 529 and EP-A-451 878 and are incorporated by reference in the present application. In an embodiment, the crop or seed thereof is genetically modified containing one or more genes that confer resistance against insects, acarides, nematodes or fungi or tolerance to herbicides.

The mass ratio of any two ingredients in each combination is selected as to give the desired, for example, synergistic action. In general, the mass ratio would vary depending on the specific ingredient and how many ingredients are present in the combination. Generally, the mass ratio between any two ingredients in any combination of the present invention, independently of one another, is from 100:1 to 1:100, including from 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:34, 65:45, 64:46, 63:47, 62:48, 61:49, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, to 1:99. Preferred mass ratios between any two components of present invention are from 75:1 to 1:75, more preferably, 50:1 to 1.50, especially 25:1 to 1:25, advantageously 10:1 to 1:10, such as 5:1 to 1:5.

In an embodiment, the ratio of (I) to (II), wherein (II) is any one of (A), is 1:10 to 500:1, such as 1:7 to 400:1, preferably 10:1 to 300:1, such as 15:1 to 80:1, preferably 20:1 to 50:1.

In an embodiment, the ratio of (I) to (II), wherein (II) is any one of (B), is likely to 1:10 to 10:1, such as 1:5 to 5:1, preferably 1:3 to 3:1.

In an embodiment, the ratio of (I) to (II), wherein (II) is (C) harpin, is 1000:1 to 5:1, such as 300:1 to 30:1, preferably 100:1 to 40:1.

In an embodiment, the ratio of (I) to (II), wherein (II) is (D) the specific bacillus firmus strain, is 15:1 to 1:3, such as 10:1 to 1:5, preferably 3:1 to 1:1.

In an embodiment, the ratio of (I) to (II), wherein (II) is Formononetin, is 5:1 to 1:5, such as 1:1 to 10:1, preferably 3:1 to 5:1.

In an embodiment, the ratio of (I) to (II), wherein (II) is Genistein, is 1:1000 to 1:150,000, such as 1:10000 to 1:100000, preferably 1:50000 to 1:80000.

In an embodiment, the ratio of (I) to (II), wherein (II) is a plant growth regulator, is 1:10 to 10:1, such as 1:5 to 5:1, preferably 1:3 to 3:1.

In an embodiment, the ratio of (I) to (II), wherein (II) is a plant activator, is 1:10 to 10:1, such as 1:5 to 5:1, preferably 1:3 to 3:1.

The rates of application (use) of a combination vary, for example, according to type of use, type of crop, the specific agent (II) in the combination, type of plant propagation material (if appropriate), but is such that the active ingredients in the combination is an effective amount to provide the desired enhanced action (such as disease or pest control) and can be determined by trials and routine experimentation known to one of ordinary skill in the art.

Generally for foliar or soil treatments, application rates can vary from 0.05 to 3 kg per hectare (g/ha) of ingredients.

Generally for seed treatments, application rates can vary from 0.5 to 1000 g/100 kg of seeds of ingredients. In an embodiment, compound (I) is applied at a rate of 30 to 500 g ai/100 kg seeds depending on the crop. Whereas the rates of application of the agents indicated in (A), (B), (C), (D) and (E) can vary depending on the specific agent and type of crop. Such rates would be readily available to a skilled person.

The plant propagation material treated by each combination of the present invention can be, therefore, resistant to pest damage; accordingly, the present invention also provides a pest resistant plant propagation material which has been treated with each combination and consequently at least the ingredients thereof are adhered on the propagation material, such as seed.

The seed treatment combinations and compositions can also comprise or may be applied together and/or sequentially with further active compounds. These further useful active compounds can be fertilizers or micronutrient donors (such as Mo, Zn and/or Co) or other preparations that influence plant growth, such as inoculants (e.g. a strain of nitrogen-fixing bacteria), plant inducers (e.g. nod factors—see US2005187107, which hereby is incorporated).

In a preferred embodiment of the invention, soybean seeds and transgenic soybean seeds are treated with a combination of the present invention. In addition, the soybean seeds may be inoculated with an appropriate strain of nitrogen-fixing bacteria for the purpose of promoting plant growth. Preferably, seeds may be inoculated with an effective bacterial strain such as Rhizobium spp. or Azospirillium spp. before sowing. The primary effect of such bacteria is in the fixation of atmospheric nitrogen into a useable form for the plant. Rhizobia bacteria, for example, is especially preferred in order to form nodules on the plant roots that are sustained by the plant and in turn provide nitrogen for the plant as mentioned above.

In a further embodiment, a soybean plant propagation material is treated with a plant inducer, e.g. a nod factor derived from Bradyrhizobium japonicum, Sinorhizobium fredii, Sinorhizobium meliloti, Bradyrhizobium sp. (Arachis), or Rhizobium leguminosarum biovar phaseoli, viceae, or trifolii.

In an aspect, the present invention also envisages use of the combinations of the present invention with glyphospate tolerant plants, especially glyphospate tolerant soybean plants, in particular for the control of asian soybean rust. Accordingly, the present invention provides a method comprising (α) applying a combination according to the invention as defined in the first aspect, especially those containing (II) one or more pesticidal agents (A), to a glyphosate tolerant plant propagation material, preferably soybean propagation material, and (β) applying a pesticidal composition (B) to the resulting plant, part of plant and/or the locus thereof one or more times (i) before emergence, (ii) after emergence, or (iii) both (i) and (ii), provided that pesticide composition (B) comprises glyphosate.

Generally, glyphosate-containing composition can be applied, if applied only once, at a rate of 960 g ae/ha; if applied twice the rate can vary from 1200 to 1680 g ae/ha. The rates and number of applications vary according to the particular conditions. Preferably, the composition (B) is applied three times with an application rate of 960, 720 and 400 g ae/ha respectively. In such an embodiment, the present invention controls, prevents or treats Phakopsora pachyrhizi and/or P. meibomiae, especially Phakopsora pachyrhizi.

Each of the combinations of the present invention may also comprise alkali metal, alkaline earth metal, metal, or ammonium salts. Zinc chloride and alkali metal, alkaline earth metal, or ammonium salts of mineral acids, especially nitrates, phosphates, sulfates, chlorides, and carbonates of sodium, potassium, ammonium, magnesium, and calcium are preferred.

Depending upon the particular plant propagation material to be treated, the conditions under which it is to be stored, and the soil and weather conditions under which it is expected to germinate and grow, the combinations of the present invention may include a wide spectrum of one or more additives. Such additives include, but are not limited to, uv-protectants, pigments, dyes, extenders such as flour, dispersing agents, excipients, anti-freezing agents, preservatives, herbicidal safeners, seed safeners, seed conditioners, micronutients, fertilizers, biocontrol agents, surfactants, sequestering agents, plasticizers, colorants, brighteners, emulsifiers, flow agents such as calcium stearate, talc and vermiculite, coalescing agents, defoaming agents, humectants, thickeners, waxes, bactericides, insecticides, pesticides, and fillers such as cellulose, glass fibers, clay, kaolin, talc, pulverized tree bark (e.g., Douglas fir bark or alderbark), calcium carbonate and wood meal, and odor-modifying agents. Typical excipients include finely divided mineral substances such as pumice, attapulgite, bentonite, kaoline zeolite, diatomite, and other clays, modified diatomaceous adsorbents, charcoal, vermiculite, finely divided organic substances such as peat moss, wood powder, and the like. Such additives are commercially available and known in the art.

The insecticidal compound (I) and one or more agents (II), and optionally any other pesticides, may be used either in pure form, i.e., as a solid active ingredient, for example, in a specific particle size, or preferably together with at least one of the auxiliary (also known as adjuvants) customary in formulation technology, such as extenders, e.g., solvents or solid carriers, or surface-active compounds (surfactants), in the form of a formulation, in the present invention. Generally, the insecticidal compound (I) and one or more agents (II) are in the form of a formulation composition with one or more of customary formulation auxiliaries.

Therefore, each combination of the insecticidal compound (I) and one or more agents (II) is normally used in the form of formulations. The ingredients in the combination can be applied to the locus where control is desired either simultaneously or in succession at short interval, for example on the same day, if desired together with further carriers, surfactants or other application-promoting adjuvants customarily employed in formulation technology. In a preferred embodiment, the ingredients in the combination are applied simultaneously.

In the event ingredients of the combinations are applied simultaneously in the present invention, they may be applied as a composition containing the combination, in which case each of (I) and (II) can be obtained from a separate formulation source and mixed together (known as a tank-mix, ready-to-apply, spray broth, or slurry), optionally with other pesticides, or (I) and (II) can be obtained as single formulation mixture source (known as a pre-mix, concentrate, formulated product), and optionally mixed together with other pesticides.

In an embodiment, each combination of the present invention is applied as a composition. Accordingly, the present invention includes a composition comprising (I) and (II), and optionally other pesticides, and optionally one or more customary formulation auxiliaries; which may be in the form of a tank-mix or pre-mix composition.

In an embodiment, each combination of (I) and (II) with one or more customary formulation auxiliaries is provided in the form of a pre-mix composition (or formulated product).

Alternative to the actual synergistic action with respect to pesticidal activity, the combinations according to the invention also can have surprising advantageous properties which can also be described, in a wider sense, as synergistic activity. Examples of such advantageous properties that may be mentioned are: advantageous behaviour during formulation and/or upon application, for example upon grinding, sieving, emulsifying, dissolving or dispensing; increased storage stability; improved stability to light; more advantageous degradability; improved toxicological and/or ecotoxicological behaviour; or any other advantages familiar to a person skilled in the art.

Examples of foliar formulation types for pre-mix compositions are:

### GR: Granules

WP: wettable powders
WG: water dispersable granules (powders)
SG: water soluble granules
SL: soluble concentrates
EC: emulsifiable concentrate
EW: emulsions, oil in water
ME: micro-emulsion
SC: aqueous suspension concentrate
CS: aqueous capsule suspension
OD: oil-based suspension concentrate, and
SE: aqueous suspo-emulsion.

Whereas, examples of seed treatment formulation types for pre-mix compositions are:

WS: wettable powders for seed treatment slurry
LS: solution for seed treatment
ES: emulsions for seed treatment
FS: suspension concentrate for seed treatment
WG: water dispersible granules, and
CS: aqueous capsule suspension.

Examples of formulation types suitable for tank-mix compositions are solutions, dilute emulsions, suspensions, or a mixture thereof, and dusts.

As with the nature of the formulations, the methods of application, such as foliar, drench, spraying, atomizing, dusting, scattering, coating or pouring, are chosen in accordance with the intended objectives and the prevailing circumstances.

The tank-mix compositions are generally prepared by diluting with a solvent (for example, water) the one or more pre-mix compositions containing different pesticides, and optionally further auxiliaries.

Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

The formulations are prepared in known manner, e.g., by homogeneously mixing and/or grinding the active ingredients with extenders, e.g., solvents, solid carriers and, where appropriate, surface-active compounds (surfactants).

Suitable solvents are: aromatic hydrocarbons, preferably the fractions containing 8 to 12 carbon atoms, e.g. xylene mixtures or substituted naphthalenes, phthalates, such as dibutyl phthalate or dioctyl phthalate, aliphatic hydrocarbons, such as cyclohexane or paraffins, alcohols and glycols and their ethers and esters, such as ethanol, ethylene glycol, ethylene glycol monomethyl or monoethyl ether, ketones, such as cyclohexanone, strongly polar solvents, such as N-methyl-2-pyrrolidone, dimethyl sulfoxide or dimethylformamide, as well as vegetable oils or epoxidised vegetable oils, such as epoxidised coconut oil or soybean oil; or water.

The solid carriers used, e.g., for dusts and dispersible powders, are normally natural mineral fillers, such as calcite, talcum, kaolin, montmorillonite or attapulgite. In order to improve the physical properties it is also possible to add highly dispersed silicic acid or highly dispersed absorbent polymers. Suitable granulated adsorptive carriers are porous types, for example pumice, broken brick, sepiolite or bentonite, and suitable nonsorbent carriers are, for example, calcite or sand. In addition, a great number of pregranulated materials of inorganic or organic nature can be used, e.g., especially dolomite or pulverized plant residues.

Depending upon the nature of the ingredients to be formulated, suitable surface-active compounds are non-ionic, cationic and/or anionic surfactants having good emulsifying, dispersing and wetting properties. The term “surfactants” will also be understood as comprising mixtures of surfactants.

Particularly advantageous application-promoting adjuvants are also natural or synthetic phospholipids of the cephalin and lecithin series, e.g., phosphatidylethanolamine, phosphatidylserine, phosphatidylglycerol and lysolecithin.

Generally, a tank-mix formulation for foliar or soil application comprises 0.1 to 20%, especially 0.1 to 15%, of the desired ingredients, and 99.9 to 80%, especially 99.9 to 85%, of a solid or liquid auxiliaries (including, for example, a solvent such as water), where the auxiliaries can be a surfactant in an amount of 0 to 20%, especially 0.1 to 15%, based on the tank-mix formulation.

Typically, a pre-mix formulation for foliar application comprises 0.1 to 99.9%, especially 1 to 95%, of the desired ingredients, and 99.9 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Normally, a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation.

Typically, a pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Whereas commercial products will preferably be formulated as concentrates (e.g., pre-mix composition (formulation)), the end user will normally employ dilute formulations (e.g., tank mix composition).

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art.

In general, the pre-mix compositions of the invention contain 0.5 to 99.9 especially 1 to 95, advantageously 1 to 50, %, by mass of the desired ingredients, and 99.5 to 0.1, especially 99 to 5, %, by mass of a solid or liquid adjuvant (including, for example, a solvent such as water), where the auxiliaries (or adjuvant) can be a surfactant in an amount of 0 to 50, especially 0.5 to 40, %, by mass based on the mass of the pre-mix formulation.

A preferred embodiment is a plant propagation material treating (or protecting) composition, wherein said plant propagation material protecting composition comprises additionally a colouring agent. The plant propagation material protecting composition or mixture may also comprise at least one polymer from water-soluble and water-dispersible film-forming polymers that improve the adherence of the active ingredients to the treated plant propagation material, which polymer generally has an average molecular weight of at least 10,000 to about 100,000.

The Examples which follow serve to illustrate the invention.

### FORMULATION EXAMPLES

| Wettable powders | a) | b) | c) |
|---|---|---|---|
| active ingredients | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

Emulsifiable concentrate

| | |
|---|---|
| active ingredients | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| Active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

Extruder granules

| | |
|---|---|
| Active ingredients | 15% |
| sodium lignosulfonate | 2% |
| carboxymethylcellulose | 1% |
| Kaolin | 82% |

The combination is mixed and ground with the adjuvants, and the mixture is moistened with water. The mixture is extruded and then dried in a stream of air.

Coated granules

| | |
|---|---|
| Active ingredients | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

Suspension concentrate

| | |
|---|---|
| active ingredients | 40% |
| propylene glycol | 10% |
| nonylphenol polyethylene glycol ether (15 mol of ethylene oxide) | 6% |
| Sodium lignosulfonate | 10% |
| carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable concentrate for seed treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution in | 0.5% |
| water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Slow Release Capsule Suspension

28 parts of the combination are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

Using such formulations, either straight or diluted, plant propagation material can be treated and protected against pest damage, for example, from pathogen(s), by, for example, spraying, pouring or immersing.

The combinations according to the invention are distinguished by the fact that they are especially well tolerated by plants and are environmentally friendly.

In an embodiment, the combinations according to the invention can also be used to treat stored products, such as grain, for protection against pathogens and/or pests.

Each combination according to the invention is especially advantageous for the treatment of plant propagation material.

In a preferred embodiment, each of the combinations of the present invention is a plant propagation material, preferably seed, treating composition.

In each aspect and embodiment of the invention, “consisting essentially” and inflections thereof are a preferred embodiment of “comprising” and its inflections, and “consisting of” and inflections thereof are a preferred embodiment of “consisting essentially of” and its inflections.

Use of a term in a singular form also encompasses that term in plural form and vice a versa.

Certain compounds defined in the first aspect are active ingredients for use in the agrochemical industry (also known as pesticides). A description of their structure as well as the structures of other pesticides (e.g., fungicides, insecticides, nematicides) can be found in the e-Pesticide Manual, version 3.1, 13th Edition, Ed. CDC Tomlin, British Crop Protection Council, 2004-05.

The compound of formula (X) is described in WO 07/095,229 and is designated as compound 2 at page 15. In an embodiment, the compound of formula (X) is a mixture of isomers Xa and Xb in a ratio of between 1:3 to 3:1, such as 1:1.5 to 1.5:1, preferably 1:1, by weight.

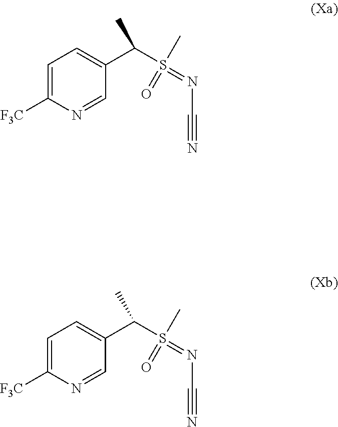

Accordingly, in a preferred embodiment each combination herein comprises as component (I) a 1:1, by weight, mixture of compound of formula (Xa) and (Xb).

The compounds of formula (α) and its manufacturing processes starting from known and commercially available compounds is described in WO 03/074491, WO 2006/015865 and WO 2006/015866.

The compound of formula (β) is described in WO 03/010149 and WO 05/58839.

The compound of formula (δ) is also known as Cyazapyr™ and is described in WO04067528 as Example 5.

Details of Bacillus firmus strain I-1582 is given in U.S. Pat. No. 6,406,690. It is available under the brand BioNem™.

Harpin (CAS RN 151438-54-9) is a protein produced by the plant pathogenic bacterium, Erwinia amylovora. It is available under the brand Messenger™. It is described in U.S. Pat. No. 5,849,868 and U.S. Pat. No. 5,776,889. Harpin was disclosed as a plant activator, for example, in WO 95/31564. In some instances, harpin is known to have nematicidal characteristics and accordingly in such instances, the present invention also relates to combinations which contain harpin in such instances.

1. A combination, suitable for agricultural use comprising (I) a compound of formula (X) and (II) one or more agents selected, independently of each other, from any one of (A) to (E):
(A) azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β);
(B) thiamethoxam, clothianidin, imidacloprid, abamectin, fipronil, pymetrozine, lambda-cyhalothrin, tefluthrin, beta-cyfluthrin, thiodicarb, compound of formula (δ);
(C) Harpin;
(D) Bacillus firmus strain 1-1582;
(E) Formononetin, Genistein;
(F) a plant growth regulator, such as paclobutrazol, trinexapac-ethyl, and gibberellins GA3, GA7 or a mixture thereof; and
(G) a plant activator, such as acibenzolar-S-methyl,
wherein compound of formulae (X), (α), (β), and (δ) are:
a compound (X) 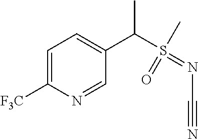
a compound (α) 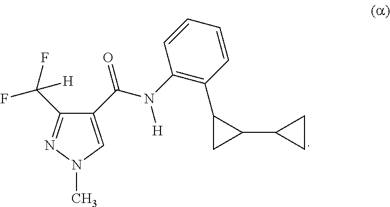
a compound (β) 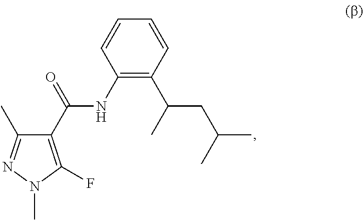
compound (δ)

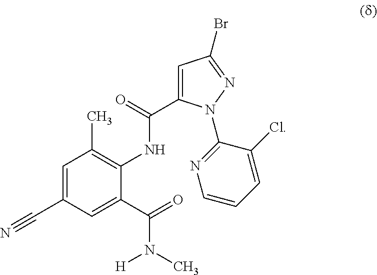

2. The combination according to claim 1 wherein the mass ratio of between any two ingredients in the combination is from 100:1 to 1:100.

3. The combination according to claim 1, wherein (II) is one or more selected from azoxystrobin, cyproconazole, difenoconazole, tebuconazole, fludioxonil, thiabendazole, cyprodinil, myclobutanil, metalaxyl, metalaxyl-M (also known as mefenoxam), ortho-cyclopropyl-carboxanilide of formula (α) defined in claim 1, thiamethoxam, abamectin, pymetrozine, fipronil, lambda-cyhalothrin, tefluthrin, compound of formula (δ) defined in claim 1, Bacillus firmus strain I-1582, Formononetin, Genistein, paclobutrazol, trinexapac-ethyl, and gibberellins GA3, GA7 or a mixture thereof and acibenzolar-S-methyl.

4. The combination according to claim 1, wherein (II) is one or more selected from trifloxystrobin, fluoxastrobin, prothioconazole, tebuconazole, triticonazole, ipconazole, metalaxyl, compound of formula (β) defined in claim 1, clothianidin, imidacloprid, abamectin, fipronil, pymetrozine, beta-cyfluthrin, thiodicarb, Harpin, Bacillus firmus strain I-1582, Formononetin and Genistein.

5. The combination according to claim 3, wherein (II) is one or more selected from azoxystrobin, fludioxonil, thiabendazole, metalaxyl-M (also known as mefenoxam), ortho-cyclopropyl-carboxanilide of formula (α), thiamethoxam, abamectin, pymetrozine, fipronil, lambda-cyhalothrin, Bacillus firmus strain I-1582, Formononetin, Genistein, paclobutrazol, trinexapac-ethyl, and acibenzolar-S-methyl.

6. The combination according to claim 1, wherein the combination further comprises one or more additional fungicides.

7. The combination according to claim 1, wherein the combination further comprises one or more insecticides.

8. The combination according to claim 1, wherein the combination further comprises one or more nematicides.

9. The combination according to claim 1, wherein the combination further comprises one or more customary formulation auxiliaries.

10. A combination comprising a compound of formula (X), (B) thiamethoxam, and (A) one or more of abamectin, lamba-cyhalothrin, tefluthrin, fipronil and a compound of formula (δ), optionally comprising (A) one or more of azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), ortho-cyclopropyl-carboxanilide of formula (α), compound of formula (β), wherein compound of formulae (X), (α), and (δ) are:
a compound (X) 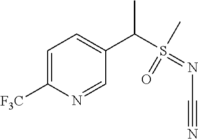
a compound (α) 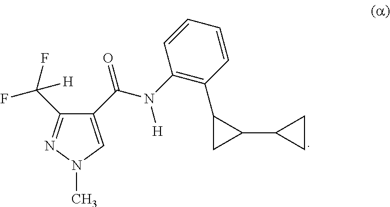
compound (δ)

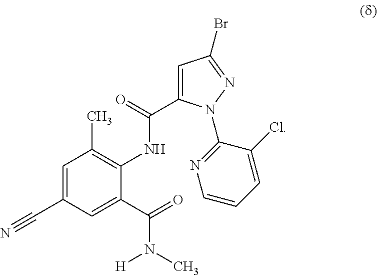

11. A method of controlling or preventing pest damage in a plant propagation material, a plant, part of a plant and/or plant organ that grow at a later point in time, which comprises applying on the pest, plant, part of the plant, plant organ, plant propagation material or a surrounding area thereof, the ingredients of the combination, as defined in claim 1, in any desired sequence or simultaneously.

12. A method of protecting a plant propagation material, a plant, part of a plant and/or plant organ that grow at a later point in time against pest damage by applying to the pest, plant, part of plant, plant organ, plant propagation material or a surrounding area thereof the ingredients of the combination, as defined in claim 1, in any desired sequence or simultaneously

13. A method of improving the growing characteristics of a plant, which comprises applying to the plant, part of plant, and/or plant propagation material, the ingredients of the combination, as defined in claim 1, in any desired sequence or simultaneously.

14. The method according to claim 11 wherein the ingredients in the combination, as defined in claim 1, is applied simultaneously.

15. The method according to claim 11, wherein the combination, as defined in claim 1, is applied on plant propagation material.

16. A plant propagation material treated with the combination as defined in claim 1.
